(19) United States
(12) Patent Application Publication
(10) Pub. No.: US 2021/0056127 A1
(43) Pub. Date: Feb. 25, 2021

(54) METHOD FOR MULTI-MODAL RETRIEVAL AND CLUSTERING USING DEEP CCA AND ACTIVE PAIRWISE QUERIES

(71) Applicant: NEC Laboratories America, Inc., Princeton, NJ (US)

(72) Inventors: Yuncong Chen, Plainsboro, NJ (US); Hao Yuan, College Station, TX (US); Cristian Lumezanu, Princeton Junction, NJ (US); Haifeng Chen, West Windsor, NJ (US); Takehiko Mizoguchi, Princeton, NJ (US); Dongjin Song, Princeton, NJ (US)

(21) Appl. No.: 16/996,110

(22) Filed: Aug. 18, 2020

Related U.S. Application Data
(60) Provisional application No. 63/021,208, filed on May 7, 2020.
(60) Provisional application No. 62/890,013, filed on Aug. 21, 2019.

(51) Int. Cl. G06F 16/335; G06F 16/33; G06F 16/35; G06N 20/00

(52) U.S. Cl. CPC G06F 16/337; G06N 20/00; G06F 16/355; G06F 16/3347

(57) ABSTRACT

A method for embedding learning and clustering for paired multi-modal data using deep canonical correlation analysis and active learning with pairwise queries is presented. The method includes collecting time-series data from a plurality of sensors, training, in an unsupervised manner, a cross-modal retrieval system by using the time-series data and relevant comment texts, depending on a modality of a query, retrieving the relevant comment texts from a time-series segment of the time-series data, the relevant comment texts used as human-readable explanations of a query segment, retrieving relevant time-series segments given a sentence or a set of keywords such that the relevant time-series segments match the sentence or set of keywords, and retrieving the relevant time-series segments given the time-series segment and the sentence or set of keywords such that a first subset of attributes match the set of keywords and a second subset of attributes resembles the time-series segment.

### RELATED APPLICATION INFORMATION

This application claims priority to Provisional Application No. 62/890,013, filed on Aug. 21, 2019, and Provisional Application No. 63/021,208, filed on May 7, 2020, the contents of which are incorporated herein by reference in their entirety.

### BACKGROUND

### Technical Field

The present invention relates to time-series data and, more particularly, to a method for multi-modal retrieval and clustering using deep canonical correlation analysis (CCA) and active pairwise queries.

### Description of the Related Art

Time-series (TS) data are prevalent in the big-data era. One example is industrial monitoring where readings of a large number of sensors constitute complex time-series. Modern data analytics software use machine learning to detect patterns from time-series. However, current analytics software is not very user-friendly. For example, the following issues are very common. While machine learning systems can perform specific classification tasks, the results are usually returned without explanations. Users want machine analysis results presented in a more elaborate and natural way. With an ever-increasing volume of time-series data, automated search over historical data becomes necessary. Traditionally, example segments are used as search queries. However, there is often a need to use more descriptive queries. Database query languages such as structed query language (SQL) may express more complex criteria but is not comprehensible for the average user.

Meanwhile, in many real-world scenarios, time-series are tagged with text comments written by domain experts. For example, when a power plant operator notices a sensor failure, the operator may write notes describing the signal shape, causes, solutions and expected future state. Such data includes paired examples of two modalities. Facilities may have accumulated large amounts of such multi-modal data over the course of their operation. Multi-modal data can be used to learn a correlation between time-series data and human explanations. Multi-modal data are also a good resource for learning knowledge of specific application domains. Despite that such data is costly to obtain, there is currently no easy way to make use of such multi-modal data.

### SUMMARY

A computer-implemented method for embedding learning and clustering for paired multi-modal data using deep canonical correlation analysis (CCA) and active learning with pairwise queries is presented. The method includes collecting time-series data from a plurality of sensors, training, in an unsupervised manner, a cross-modal retrieval system by using the time-series data and relevant comment texts, depending on a modality of a query, retrieving the relevant comment texts from a time-series segment of the time-series data, the relevant comment texts used as human-readable explanations of a query segment, retrieving relevant time-series segments given a sentence or a set of keywords such that the relevant time-series segments match the sentence or set of keywords, and retrieving the relevant time-series segments given the time-series segment and the sentence or set of keywords such that a first subset of attributes match the set of keywords and a second subset of attributes resembles the time-series segment.

A non-transitory computer-readable storage medium comprising a computer-readable program is presented for embedding learning and clustering for paired multi-modal data using deep canonical correlation analysis (CCA) and active learning with pairwise queries, wherein the computer-readable program when executed on a computer causes the computer to perform the steps of collecting time-series data from a plurality of sensors, training, in an unsupervised manner, a cross-modal retrieval system by using the time-series data and relevant comment texts, depending on a modality of a query, retrieving the relevant comment texts from a time-series segment of the time-series data, the relevant comment texts used as human-readable explanations of a query segment, retrieving relevant time-series segments given a sentence or a set of keywords such that the relevant time-series segments match the sentence or set of keywords, and retrieving the relevant time-series segments given the time-series segment and the sentence or set of keywords such that a first subset of attributes match the set of keywords and a second subset of attributes resembles the time-series segment.

A system for embedding learning and clustering for paired multi-modal data using deep canonical correlation analysis (CCA) and active learning with pairwise queries is presented. The system includes a memory and one or more processors in communication with the memory configured to collect time-series data from a plurality of sensors, train, in an unsupervised manner, a cross-modal retrieval system by using the time-series data and relevant comment texts, depending on a modality of a query, retrieve the relevant comment texts from a time-series segment of the time-series data, the relevant comment texts used as human-readable explanations of a query segment, retrieve relevant time-series segments given a sentence or a set of keywords such that the relevant time-series segments match the sentence or set of keywords, and retrieve the relevant time-series segments given the time-series segment and the sentence or set of keywords such that a first subset of attributes match the set of keywords and a second subset of attributes resembles the time-series segment.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary overall training procedure, in accordance with embodiments of the present invention;

FIG. 2 is a block/flow diagram of an exemplary deep canonical correlation analysis (CCA) stage, in accordance with embodiments of the present invention;

FIG. 3 is a block/flow diagram of an exemplary semi-supervised stage, in accordance with embodiments of the present invention;

FIG. 4 is a block/flow diagram of an exemplary active query selection based on a gaussian mixture model (GMM), in accordance with embodiments of the present invention;

FIG. 5 is a block/flow diagram of an exemplary query selection based on active spectral clustering, in accordance with embodiments of the present invention;

FIG. 6 is a block/flow diagram of an exemplary clustering procedure, in accordance with embodiments of the present invention;

FIG. 7 is a block/flow diagram of an exemplary method for retrieval of relevant data for unseen queries, in accordance with embodiments of the present invention;

FIG. 8 is a block/flow diagram of an exemplary method for retrieval of time-series by natural language, in accordance with embodiments of the present invention;

FIG. 9 is a block/flow diagram of an exemplary method for employing a joint modality search, in accordance with embodiments of the present invention;

FIG. 10 is a block/flow diagram of an exemplary cross-modal retrieval system, in accordance with embodiments of the present invention;

FIG. 11 is a block/flow diagram of an exemplary architecture of the text comment encoder, in accordance with embodiments of the present invention;

FIG. 12 is block/flow diagram of an exemplary processing system for the multi-modal retrieval and clustering using CCA and active pairwise queries, in accordance with embodiments of the present invention;

FIG. 13 is a block/flow diagram of an exemplary method for the multi-modal retrieval and clustering using CCA and active pairwise queries, in accordance with embodiments of the present invention; and

FIG. 14 is a block/flow diagram of a practical application for the multi-modal retrieval and clustering using CCA and active pairwise queries, in accordance with embodiments of the present invention.

### DETAILED DESCRIPTION OF PREFERRED EMBODIMENTS

Time-series in the real world are often tagged with text comments written by domain experts. While most existing studies reduce the role of text comments to class labels, a deeper understanding can be gained by analyzing the complete text comments and by considering the text comments jointly with time-series.

Time-series data are prevalent in the big-data era. One example is industrial monitoring where readings from a large number of sensors in an industrial facility (e.g., a power plant) constitute time-series that exhibit complex patterns. Algorithms have been designed to automatically analyze time-series patterns and solve specific tasks, but these results are usually given without explanations that are understandable by human users. This significantly reduces the confidence users have regarding the results and limits the potential impact that automated analytics can have on the actual decision process.

Meanwhile, meaningful interpretation of time-series often requires domain expertise. In many real-world scenarios, time-series are tagged with comments written by human experts. Although in some cases the comments are no more than categorical labels, more often they are free-form natural texts. These expert-written comments are readable, elaborative and provide domain-specific insights. For example, a comment from a power plant operator may include a description of the shape of the anomalous signals, the root causes, the actions taken to correct the issue, and the prediction of future status.

These are the type of high-quality and effective explanations with respect to time-series that users desire. In addition, there is a need to search for relevant time-series segments using text as a query. Compared to traditional single-modality time-series retrieval systems, using text that describes the properties of desired targets allows forming semantic/abstract and potentially complex queries in a natural way. This translates to higher accuracy of retrieving results that match the users' expectations.

Furthermore, comment data have been accumulated in many facilities over the course of their operation. Despite the high cost of soliciting comments from experts, most of them are usually not re-used. There is currently no easy way to extract values from historical comments, although historical comments clearly include valuable domain knowledge. Such knowledge may include important concepts in this domain. In the context of power plant operation, the concepts may include steam pressure and maneuver of turning off a valve. In other words, the comments contain the materials for constructing a domain-specific knowledge base. The availability of associated time-series provides more possibility for concept discovery because of the additional view of the data.

The exemplary embodiments of the present invention introduce a unified approach to address such issues. More concretely, the exemplary methods provide a method for retrieving relevant time-series segments or text comments, given a potentially multi-modal query (e.g., time-series segment and/or text description), and a method for automatically discovering common concepts underlying a multi-modal dataset. There are several modes of using the exemplary embodiments for retrieval, that is, given a time-series segment, retrieve relevant comments which can be used as human-readable explanations of the time-series segment. Natural language search, that is, given a sentence or set of keywords, retrieve relevant time-series segments. Joint-modality search, that is, given a time-series segment and a sentence or a set of keywords, retrieve relevant time-series segments such that a subset of the attributes match the keywords and the remaining attributes are similar to or resemble the given time-series segment.

At a high level, the exemplary methods transform the time-series segment and the text comments into points in a common latent space, such that examples of the same class and examples in the same pair are close together. Cross-modal retrieval is performed by finding the nearest neighbors of a query in this common space. Concepts discovery is performed by clustering the data points in this space.

Compared to purely supervised or unsupervised methods, the exemplary methods use active semi-supervised learning so that human knowledge can guide the learning while manual labeling effort can be significantly reduced without sacrificing performance.

Most active learning algorithms query the label of individual examples. However, in practice, the set of concepts involved in a dataset in a new application domain are often unknown, making it difficult for an annotator to provide labels for individual examples. To this end, the exemplary methods only use queries regarding whether two examples belong to the same concept or not. After obtaining a sufficient number of pairwise labels, the exemplary methods can then choose to infer the set of concepts and the labels of every example.

The exemplary methods use deep canonical correlation analysis (CCA) as an unsupervised objective. CCA finds transformations of time-series segments and of text data, such that correlated information in the two modalities are emphasized, and uncorrelated information (noises) are minimized. The result is that the transformed data tend to show a clustered structure.

The exemplary methods use deep CCA both in the pre-training stage, and in the active learning stage as a regularizer for the supervised objective. The supervised objective encourages embeddings such that examples of the same class are closer to each other than to examples of a different class, regardless of modality. Two active pairwise query selection strategies based on active spectral clustering and gaussian mixture model (GMM) can be used.

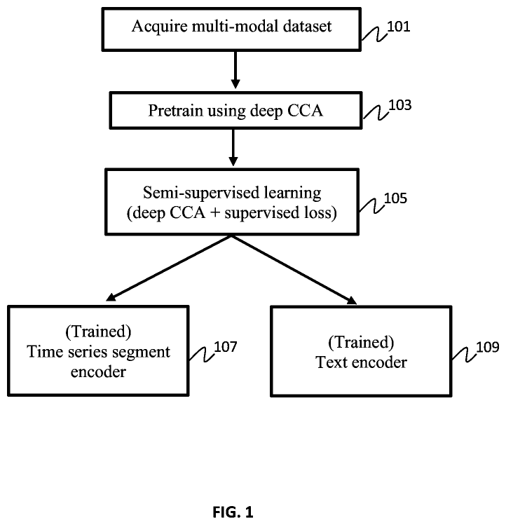

FIG. 1 is a block/flow diagram of an exemplary overall training procedure, in accordance with embodiments of the present invention.

At block 101, a multi-modal dataset is acquired.

At block 103, pre-training is performed by using deep CCA.

At block 105, semi-supervised learning is performed.

At block 107, a time-series segment encoder is used.

At block 109, a text encoder is used.

The complete training procedure is shown in Algorithm 1 below. The first stage is unsupervised pre-training of both encoders with deep CCA. Based on the resulting embedding, the second stage is CCA-regularized active learning. At each round, a fixed number of example pairs are selected either by active spectral clustering or by the GMM posterior entropy-based strategy. They are shown to human annotators who assign the relation labels based on domain knowledge or some subjective criteria. Note that the label for any pair can in fact be used to define four relations between four examples, consisting of the two examples as well as their counterparts in the opposite modality. Then using all labels acquired up to now, the exemplary embodiments train both encoders until convergence. This sample/train iteration is repeated until the query budget is reached.

Algorithm 1 DEEP ACTIVE CCA

Input:

Set of n paired bi-modal examples {(xᵢ, yᵢ)}
Query budget [symbol]
Number of pairs to sample per round k
Randomly initialized time series encoder f
Randomly initialized text encoder g

| | |
|---|---|
| 1: | Update parameters of f and g by minimizing [symbol] _{Corr} (Eq. |
| | 2) with gradient descent until convergence. |
| 2: | [symbol] = Ø, [symbol] = set of all possible pairs, t = 0 |
| 3: | while t ≤ [symbol] do |

| | |
|---|---|
| 4: | Compute embeddings {f(xᵢ)} and {g(yᵢ)}. |
| 5: | Sample a set Ω of k pairs from [symbol] using either active |

spectral clustering (Eq. 8) or the GMM-based strategy
(Eq. 10).

| | |
|---|---|
| 6: | Query annotators for pair labels. |
| 7: | Update labeled relations [symbol] ← [symbol] ∪ Ω |
| 8: | Update candidate set [symbol] ← [symbol] \ Ω |
| 9: | t ← t + k. |
| 10: | Update parameters of f and f by minimizing [symbol] (Eq. |

| | |
|---|---|
| | 12) with gradient descent until convergence. |
| 11: | end while |

With further reference to FIG. 1, the procedure starts with acquiring a database of paired data where each pair includes a time-series segment and a text comment passage. Given a database of paired data, each pair includes a time-series segment and a text comment passage. The total number of data pairs is denoted by n. The exemplary method denotes the i'th data pair by (x⁽ⁱ⁾, y⁽ⁱ⁾), where x⁽ⁱ⁾ is the time-series segment and y⁽ⁱ⁾ is the text comment. The feature vector of the i'th time-series segment is h₁⁽ⁱ⁾=f(x⁽ⁱ⁾). The feature vector of the i'th text comment is h₂⁽ⁱ⁾=g(y⁽ⁱ⁾). Suppose H₁ ∈R^{n×d}^{₁} is the feature matrix of time-series segments, such that the i'th row of H₁ is h⁽ⁱ⁾.H₂∈R^{n×d}^{₂} is the feature matrix of text comments defined similarly.

The encoders 107, 109 are pre-trained using deep CCA 103. After that, in the semi-supervised learning stage 105, the encoders 107, 109 are further trained using a supervised loss based on the queried pairwise labels, in conjunction with the deep CCA regularization. The two trained encoders 107, 109 are the result of this procedure.

The pseudocode for the total correlation computation portion of this procedure is:

| | |
|---|---|
| 1: | function CCALoss(H_{X}, H_{Y}) |
| 2: | ${Σ}_{XX} = \frac{{H}_{X}^{T} {H}_{X}}{n - 1} + {r}_{1} I$ |
| 3: | ${Σ}_{YY} = \frac{{H}_{Y}^{T} {H}_{Y}}{n - 1} + {r}_{2} I$ |
| 4: | ${Σ}_{XY} = \frac{1}{n - 1} {H}_{X}^{T} {H}_{Y}$ |
| 5: | $S = {Σ}_{11}^{- \frac{1}{2}} {Σ}_{12} {Σ}_{22}^{- \frac{1}{2}}$ |
| 6: | U, Λ, V^{T} = SVD(S) |
| 7: | $c = {\sum }_{i = 1}^{min ( {d}_{1} , {d}_{2} )} {λ}_{i}$ |
| 8: | return c |
| 9: | end function |

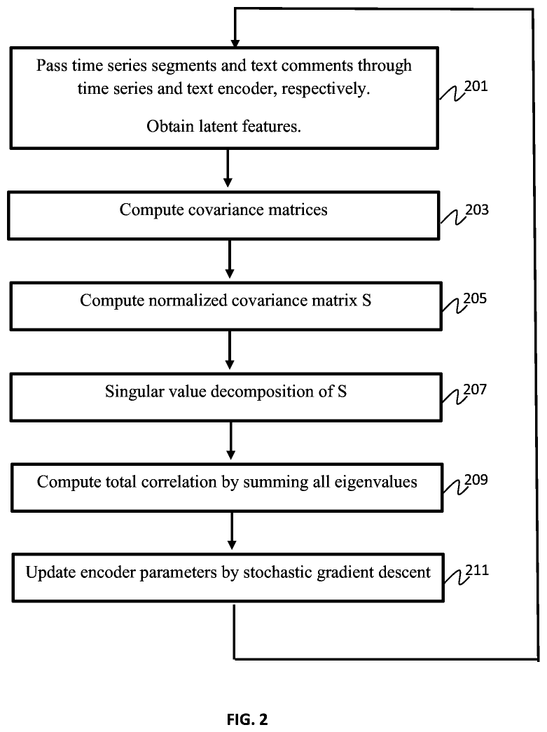

FIG. 2 is a block/flow diagram of an exemplary deep canonical correlation analysis (CCA) stage, in accordance with embodiments of the present invention.

At block 201, the time-series segments and the text comments are passed through a time-series encoder and a text encoder, respectively. Additionally, the latent features are obtained.

At block 203, the covariance matrices are computed.

At block 205, the normalized covariance matrix S is computed.

At block 207, the singular value decomposition of S is obtained.

At block 209, the total correlations are computed by summing all eigenvalues.

At block 211, the encoder parameters are updated by stochastic gradient descent.

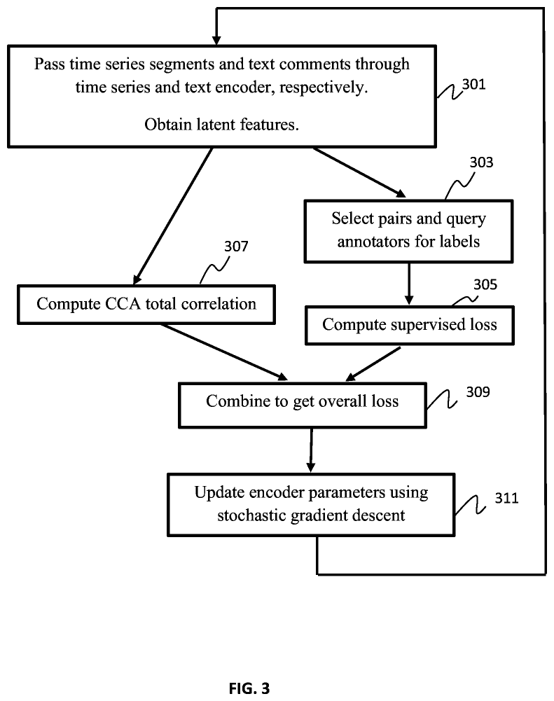

FIG. 3 shows the procedure of the semi-supervised learning stage.

The procedure starts from the pre-trained encoders.

At block 301, time-series segments and text comments are passed through time-series and text encoders, respectively. Additionally, the feature vectors are obtained.

At block 303, select pairs using one of the proposed strategies and query annotators for the labels of selected pairs.

At block 305, compute the supervised loss Lₛᵤₚ based on all pair labels that have been queried up to now.

At block 307, compute the total correlation c, according to pseudocode lines 2-7.

At block 309, combine the supervised loss and the total correlation to get the overall loss. L=Lₛᵤₚ+ηc. Hyper-parameter η is chosen by cross-validation.

At block 311, compute the gradient of total correlation with respect to parameters of both encoders. Additionally, update the parameters by stochastic gradient descent.

Regarding CCA-regularized semi-supervised learning, after the pre-training stage using CCA, in the semi-supervised learning stage, the exemplary methods alternate between adaptive querying and supervised training. For adaptive querying, the exemplary methods use either one of two strategies (detailed below) to adaptively select pairs of data, and then query their pairwise relation labels from a human annotator. The pairwise relation labels are either 1 (“must-link”) if they are considered to be the same class or −1 (“cannot-link”) if they are considered to be of different classes. Meanwhile supervised training uses these queried relation labels to further improve the encoders with both supervised pairwise loss and unsupervised deep CCA loss.

For each queried pair (i,j), the relation label cᵢⱼ=1 if the human annotator considers them the same class and cᵢⱼ=−1 if otherwise. Denote by S the set of all labeled pairs. The pairwise loss is computed using cosine similarity:

$$s ( {x}_{i} , {x}_{j} ) = \frac{{e ( {x}_{i} )}^{⊤} e ( {x}_{j} )}{{‖ e ( {x}_{i} ) ‖}_{2} {‖ e ( {x}_{j} ) ‖}_{2}} , \\ {ℒ}_{Pair} = \frac{1}{\vert S \vert} {\sum }_{( {x}_{i} , {x}_{j} ) ∈ S} {‖ {c}_{ij} - s ( {x}_{i} , {x}_{j} ) ‖}_{2}^{2}$$

Because at the outset S only contains few example pairs, using the pairwise loss alone tends to cause overfitting. To counter this, the exemplary methods include the correlation maximization objective of CCA as regularization to maintain the global consistency of two modalities. This regularization is shown to be beneficial for the success of active learning under very low budgets.

The overall loss is therefore formulated as:

[symbol]

= [symbol] _{Pair}+η [symbol] _{Corr}

where η controls the strength of the regularization.

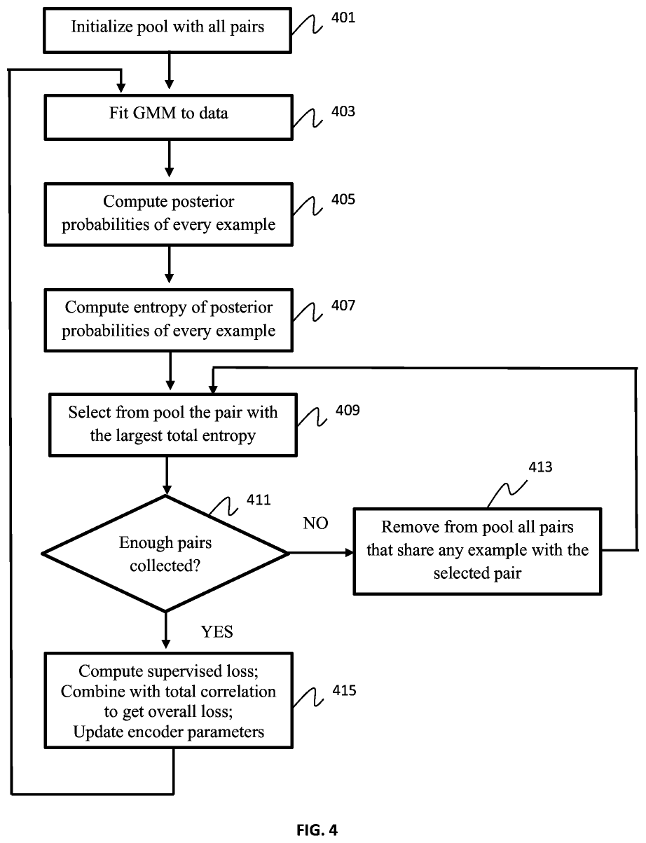

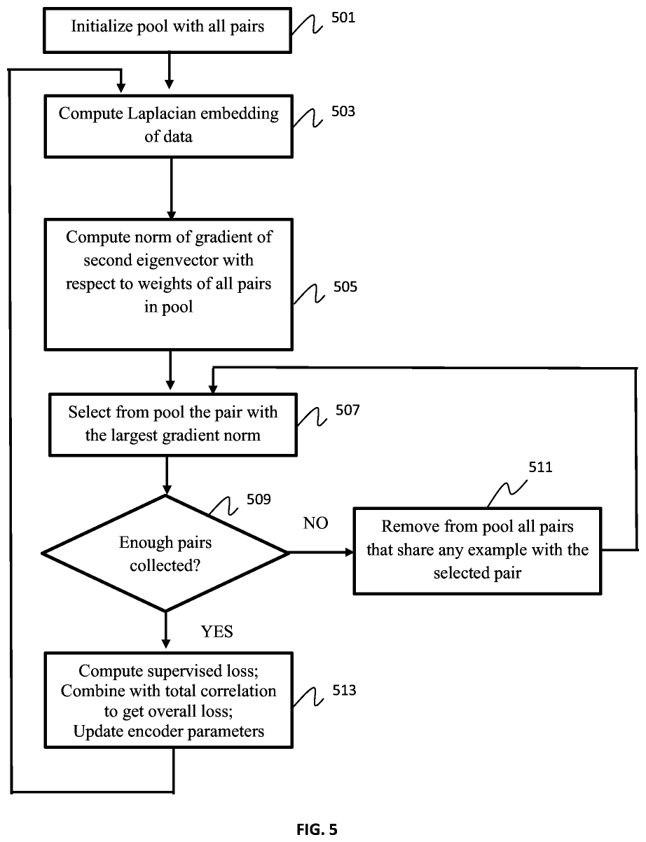

FIGS. 4 and 5 show procedures of two possible strategies for selecting pairwise queries.

FIG. 4 shows the procedure for selecting pairwise queries based on GMM.

At block 401, initialize the pool of candidate pairs with all pairs.

At block 403, fit GMM to data.

At block 405, compute posterior probabilities of every example.

At block 407, compute the entropy of these probabilities for every example.

At block 409, select from pool the pair of examples with the largest total entropy.

At block 411, if the number of selected pairs does not reach the desired number, remove from the pool all pairs that share any example with the selected pair (block 413), and return to block 409. Otherwise, continue to block 415.

At block 415, compute the supervised loss, combine with the total correlation to get the overall loss, and update the encoder parameters.

The output of this procedure goes to block 305 of the procedure for “semi-supervised stage.” (FIG. 3).

Regarding Strategy 1, the GMM posterior uncertainty, given a reasonable estimate of the number of classes, the exemplary methods fit a Gaussian mixture model to the data. The exemplary embodiments then compute the class posterior probabilities of each example, which measure the likelihood an example is affiliated with each mixture component. Uncertainty of the affiliation can be quantified by the entropy of the posterior. With the posterior of the k'th component denoted by p(cᵢ=k|xᵢ), the uncertainty score uᵢ is computed by:

$${u}_{i} = - {\sum }_{k} p ( {c}_{i} = k \vert {x}_{i} ) log p ( {c}_{i} = k \vert {x}_{i} )$$

The uncertainty score uij for a pair (i, j) is then defined as the sum of the entropy of both examples:

Score(i,j)=uᵢ+uⱼ

Then, pairs with the highest uncertainty scores are selected as queries.

FIG. 5 shows the procedure for selecting pairwise queries based on active spectral clustering.

At block 501, initialize the pool of candidate pairs with all pairs.

At block 503, compute the Laplacian embedding of data.

At block 505, compute the norm of gradient of the second eigenvector with respect to weights of all pairs in the pool.

At block 507, select from the pool the pair of examples with the largest gradient norm.

At block 509, if the number of selected pairs does not reach the desired number, remove from the pool all pairs that share any example with the selected pair (block 511), and return to block 507. Otherwise, continue to block 513.

At block 513, compute the supervised loss, combine with the total correlation to get the overall loss, and update the encoder parameters.

The output of this procedure goes to block 305 of the procedure for “semi-supervised stage.” (FIG. 3)

Regarding Strategy 2, the active spectral clustering, prior disclosures have proposed a strategy that selects example pairs that have the largest influence to the result of spectral clustering. It is observed that whether the clustering is performed on data of one modality or on data of both modalities is inconsequential. This deep CCA pretraining always converges to nearly unit correlation, and as a result two corresponding examples are usually very close in the latent space.

Denote by W the affinity matrix, with the weight between any pair of examples defined by a Gaussian kernel on their embeddings:

$${W}_{ij} = exp ( - \frac{{‖ e ( {x}_{i} ) - e ( {x}_{j} ) ‖}^{2}}{{σ}^{2}} )$$

The Laplacian matrix is computed as:

L=D−W.

where D=diag(W1) and 1 is an all-one vector.

Denote the p'th eigenvectors and eigenvalues of L by vₚ and λₚ. The importance of a pair (i, j) is quantified by the magnitude of the gradient of the second eigenvector v₂ with respect to the pair's weight:

$$Score ( i , j ) = \vert \frac{d ‖ {v}_{2} ‖}{{dw}_{ij}} \vert = \vert {\sum }_{p > 2} \frac{{v}_{2}^{⊤} [ \frac{\partial L}{\partial {w}_{ij}} ] {v}_{p}}{{λ}_{2} - {λ}_{p}} {v}_{p} \vert$$

An alternative is the simpler variant that only considers a pair's influence on the most uncertain example:

$$\begin{matrix}Score ( i , j ) = \vert \frac{{dv}_{2} ( {k}_{min} )}{{dw}_{ij}} \vert \\ = \vert {\sum }_{p > 2} \frac{{v}_{2}^{⊤} [ \frac{\partial L}{\partial {w}_{ij}} ] {v}_{p}}{{λ}_{2} - {λ}_{p}} {v}_{p} ( {k}_{min} ) \vert\end{matrix}$$

where kₘᵢₙ=argminₖ|v₂(k)|. According to this score, the exemplary methods rank all example pairs that have not yet been selected, and the top pairs are selected as the queries of the current round.

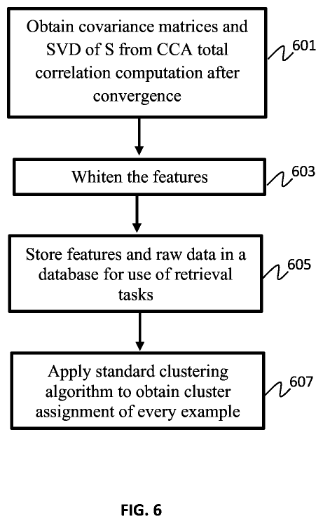

FIG. 6 shows the procedure of clustering.

At block 601, after the training converges, obtain the covariance matrices Σ₁₁, Σ₂₂, and U and V, the singular value decomposition of S as in the pseudocode.

At block 603, compute whitened features Z₁ and Z₂ by transforming the feature matrices H₁ and H₂:

Z₁=H₁Σ₁₁^{-1/2}U

Z₂=H₂Σ₂₂^{-1/2}V

At block 605, store the whitened features of all time-series segments and of all texts, together with their raw form, in a database for future retrieval.

At block 607, cluster the whitened features of either modality, Z₁ or Z₂, using any standard clustering algorithm. For example, the exemplary methods can use K-means to cluster time-series segment features Z₁, which assigns a label l⁽ⁱ⁾ to each instance x⁽ⁱ⁾. Further the exemplary method can assign l⁽ⁱ⁾ to y⁽ⁱ⁾. The clusters found in this step constitute the domain concepts discovered from the dataset.

In the test phase, the task is cross-modal retrieval. With the encoders and the database of raw data and features of both modalities available, nearest-neighbor search can be used to retrieve relevant data for unseen queries.

If the query x is a time-series segment, its feature z is computed as:

z=f(x)^{T}Σ₁₁^{-1/2}U.

If x is a text comment, its feature z is computed as:

z=g(x)^{T}Σ₂₂^{-1/2}V.

In the test phase, with the encoders and the database of raw data and features of both modalities available, nearest-neighbor search can be used to retrieve relevant data for unseen queries.

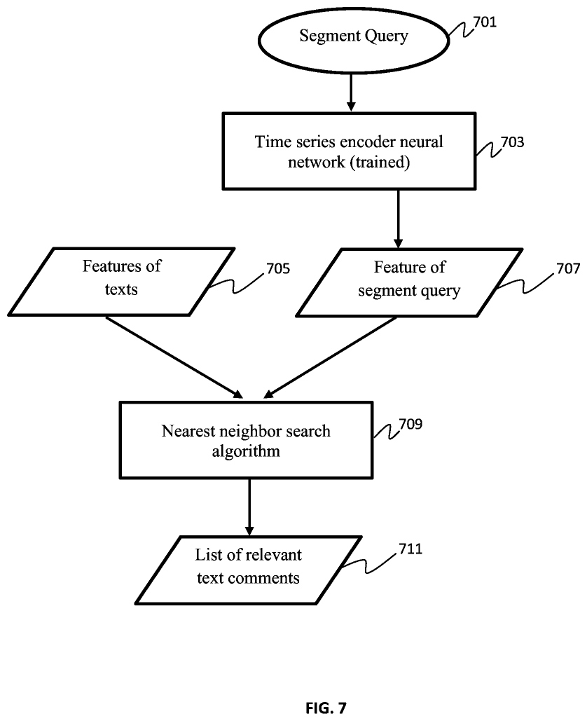

The specific procedure for each of the several application scenarios are described below with respect to FIGS. 7-9.

FIG. 7 is a block/flow diagram of an exemplary method for retrieval of relevant data for unseen queries, in accordance with embodiments of the present invention.

At block 701, a segment query is submitted.

At block 703, a time-series encoder neural network is employed.

At block 705, features of text are fed into block 709.

At block 707, features of the segment query are fed into block 709.

At block 709, the nearest neighbor search algorithm is employed after concurrently receiving the features of texts and the features of segment query.

At block 711, a list of relevant text comments is provided.

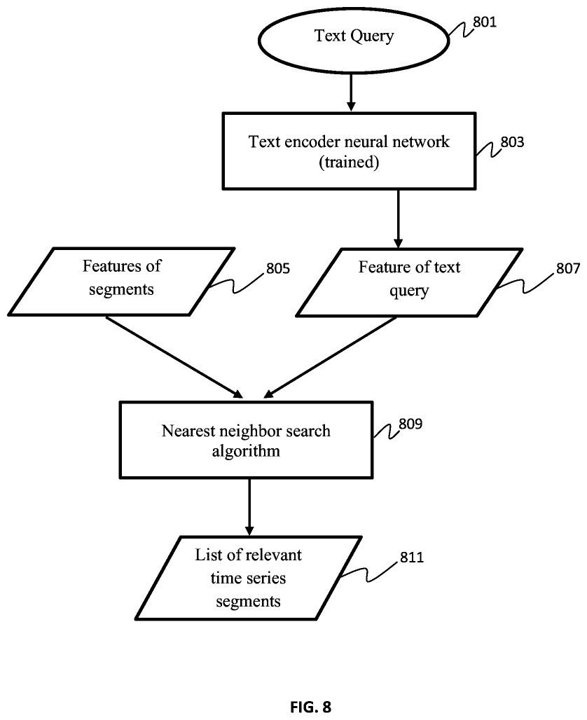

FIG. 8 is a block/flow diagram of an exemplary method for retrieval of time-series by natural language, in accordance with embodiments of the present invention.

At block 801, a text query is submitted.

At block 803, a text encoder neural network is employed.

At block 805, features of the segments are fed into block 809.

At block 807, features of the text query are fed into block 809.

At block 809, the nearest neighbor search algorithm is employed after concurrently receiving the features of segments and the features of text query.

At block 811, a list of relevant time-series segments is provided.

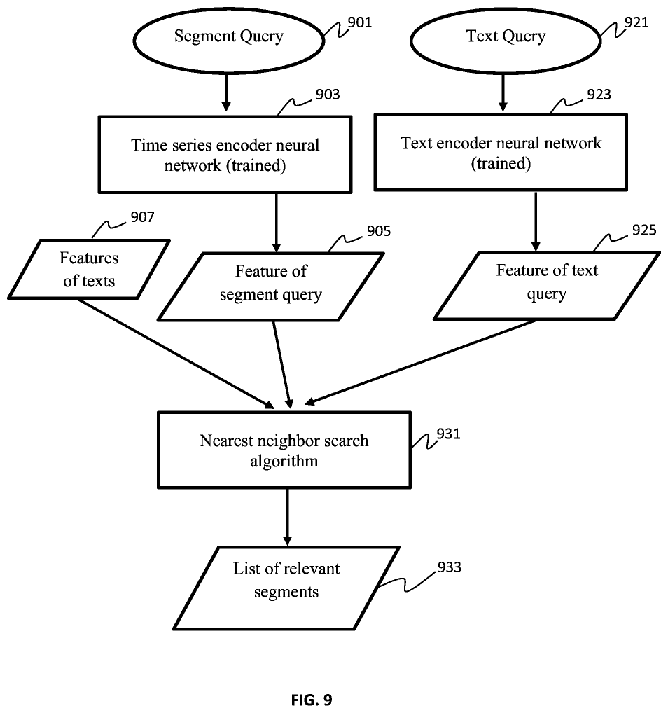

FIG. 9 is a block/flow diagram of an exemplary method for employing a joint modality search, in accordance with embodiments of the present invention.

At block 901, a segment query is submitted.

At block 903, a time-series encoder neural network is employed.

At block 905, features of the segment query are fed into block 931.

At block 907, features of texts are fed into block 931.

At block 921, a text query is submitted.

At block 923, a text encoder neural network is employed.

At block 925, features of the text query are fed into block 931.

At block 931, the nearest neighbor search algorithm is employed after concurrently receiving the features of texts, the features of segment query, and the features of text query.

At block 933, a list of relevant segments is provided.

Given the query as a time-series of arbitrary length, it is forward-passed through the time-series encoder to obtain a feature vector x. Then from the database, the exemplary method finds the k text instances whose features have the smallest (Euclidean) distance to this vector (e.g., nearest neighbors). These text instances, which are human-written free-form comments are returned as retrieval results.

Retrieval of time-series by natural language, that is, given the query as a free-form text passage (r.g., words or short sentences), it is passed through the text encoder to obtain a feature vector y. Then from the database, the exemplary method finds the k time-series instances whose features have the smallest distance toy. These time-series, which have the same semantic class as the query text, and, therefore, have high relevance to the query, are returned as retrieval results.

Joint-modality search, that is, given the query as a pair of (time-series segment, text description), the time-series is passed through the time-series encoder to obtain a feature vector x, and the text description is passed through the text encoder to obtain a feature vector y. Then from the database, the exemplary method finds the n time-series segments whose features are the nearest neighbors of x and n time-series segments whose features are the nearest neighbors of y, and their intersections are obtained. The exemplary method starts from n=k. If the number of instances in the intersection is smaller than k, the exemplary method increments n and repeats the search, until at least k instances are retrieved. These instances, semantically similar to both the query time-series and the query text, are returned as retrieval results.

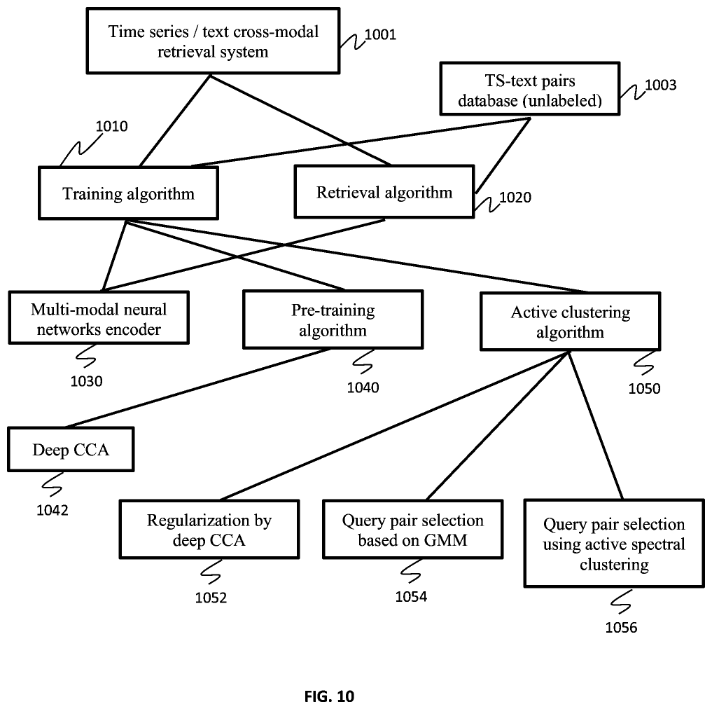

FIG. 10 is a block/flow diagram of an exemplary cross-modal retrieval system, in accordance with embodiments of the present invention.

The cross-modal retrieval system 1001 uses multimodal neural networks to encode texts and time-series data into vector representations. The neural networks are trained by the two-stage training algorithm using examples from a user-provided database 1003 of TS-text pairs. Training 1010 is unsupervised, meaning that class labels of these TS-text pairs are not required and it does not require human involvement in this process. The first stage is the deep CCA-based pre-training 1040 (using deep CCA 1042). This adjusts the neural network so that the encoders 1030 produce reasonable representations for the next learning stage. The second stage is active clustering 1050. Two query pair selection procedures can be used, one based on Gaussian mixture modeling 1054 and the other uses active spectral clustering 1056. In addition to the supervised loss, the objective in this stage additionally includes regularization by deep CCA 1052. After the neural network encoder 1030 is trained, the retrieval of data from the database according to a user-provided query is realized in accordance with the retrieval algorithm 1020.

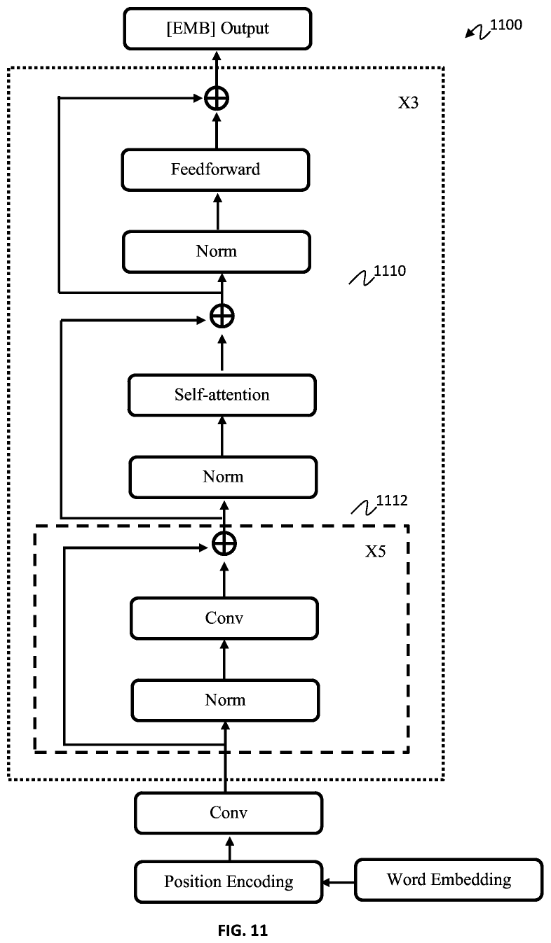

FIG. 11 is a block/flow diagram of an exemplary architecture 1100 of the text comment encoder, in accordance with embodiments of the present invention.

The exemplary methods acquire a database of paired data where each pair includes a time-series segment and a text comment passage. The total number of data pairs is denoted by n. The i'th data pair is denoted by (x⁽ⁱ⁾, y⁽ⁱ⁾) where x⁽ⁱ⁾ is the time-series segment and y⁽ⁱ⁾ is the text.

The exemplary method includes a training phase and the test phase.

The training phase of the exemplary method involves training two neural network encoders, one for time-series segments and the other for text comments.

The time-series segment encoder and the text encoder are both neural networks. The time-series segment encoder, denoted by f, takes a time-series segment as input. The text encoder, denoted by g, takes a tokenized text comment passage as input. The time-series encoder has almost the same architecture as the text encoder, except that the word embedding layer is replaced with a fully connected layer. The architecture 1100 includes a series of convolution layers 1112 followed by a transformer network 1110. The convolution layers 1112 capture local contexts (e.g., phrases for text data). The transformer 1110 encodes the longer-term dependencies in the sequence.

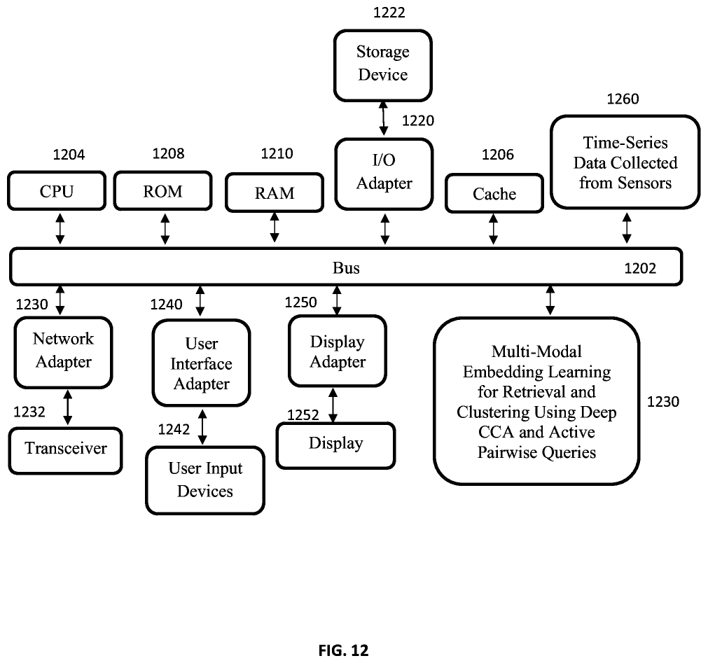

FIG. 12 is block/flow diagram of an exemplary processing system for the multi-modal retrieval and clustering using CCA and active pairwise queries, in accordance with embodiments of the present invention.

The processing system includes at least one processor or processor device (CPU) 1204 operatively coupled to other components via a system bus 1202. A cache 1206, a Read Only Memory (ROM) 1208, a Random Access Memory (RAM) 1210, an input/output (I/O) adapter 1220, a network adapter 1230, a user interface adapter 1240, and a display adapter 1250, are operatively coupled to the system bus 1202. Time-series data 1260 can be collected from sensors, the sensors connected to the bus 1202. The time-series data 1260 can be analyzed by employing multi-modal embedding learning and retrieval and clustering using deep CCA and active pairwise queries 1230.

A storage device 1222 is operatively coupled to system bus 1202 by the I/O adapter 1220. The storage device 1222 can be any of a disk storage device (e.g., a magnetic or optical disk storage device), a solid state magnetic device, and so forth.

A transceiver 1232 is operatively coupled to system bus 1202 by network adapter 1230.

User input devices 1242 are operatively coupled to system bus 1202 by user interface adapter 1240. The user input devices 1242 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 1242 can be the same type of user input device or different types of user input devices. The user input devices 1242 are used to input and output information to and from the processing system.

A display device 1252 is operatively coupled to system bus 1202 by display adapter 1250.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, processor devices, controllers, memories, and so forth, in various configurations can also be utilized as readily appreciated by one of ordinary skill in the art. These and other variations of the processing system are readily contemplated by one of ordinary skill in the art given the teachings of the present invention provided herein.

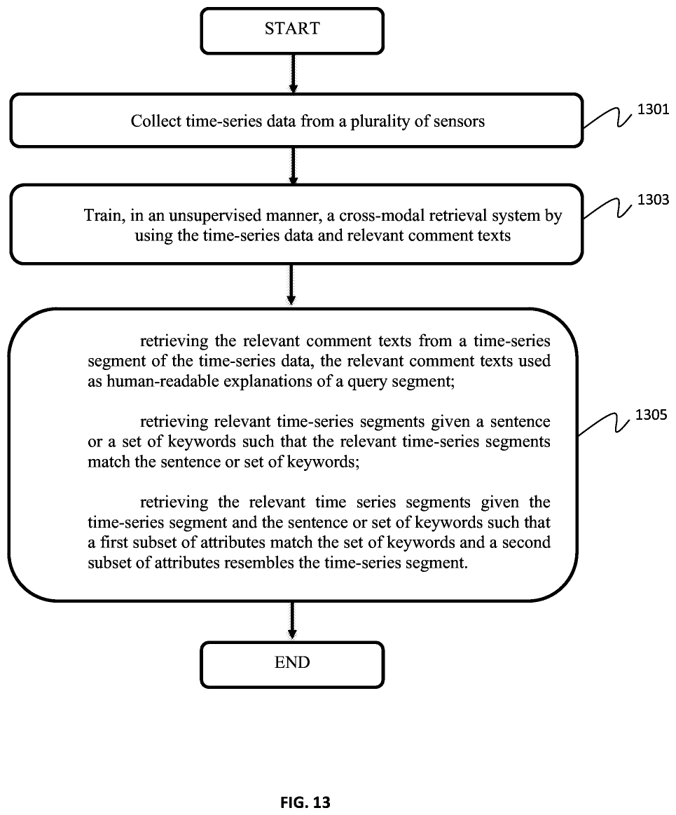

FIG. 13 is a block/flow diagram of an exemplary method for the multi-modal retrieval and clustering using CCA and active pairwise queries, in accordance with embodiments of the present invention.

At block 1301, collect time-series data from a plurality of sensors.

At block 1303, train, in an unsupervised manner, a cross-modal retrieval system by using the time-series data and relevant comment texts.

At block 1305, depending on a modality of a query:

retrieve the relevant comment texts from a time-series segment of the time-series data, the relevant comment texts used as human-readable explanations of a query segment,

retrieve relevant time-series segments given a sentence or a set of keywords such that the relevant time-series segments match the sentence or set of keywords, and

retrieve the relevant time-series segments given the time-series segment and the sentence or set of keywords such that a first subset of attributes match the set of keywords and a second subset of attributes resembles the time-series segment.

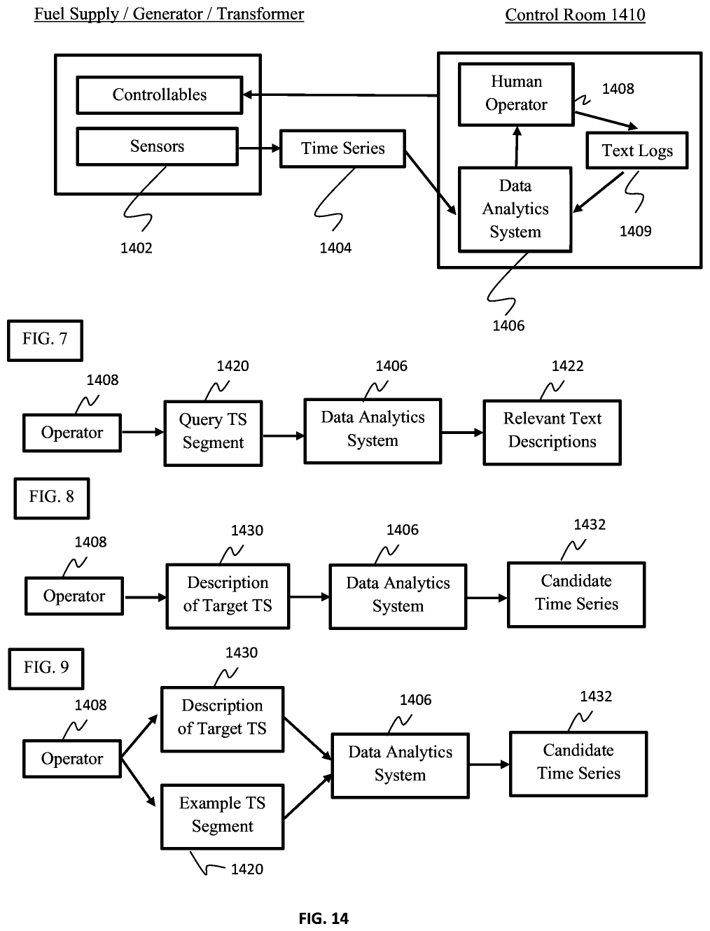

FIG. 14 is a block/flow diagram of a practical application for the multi-modal retrieval and clustering using CCA and active pairwise queries, in accordance with embodiments of the present invention.

For example, in the context of power plant operations, sensors 1402 deployed at various parts of the facility collect time-series (TS) data 1404 that characterize the status of the power generation process. TS data 1404 are transmitted to the data analytics system 1406 installed in a computer in the control room 1410. Human operators 1408 examine the data on a monitor and may create notes in free-form text 1409. If the data are abnormal, the notes are expected to include details such as cause analysis and resolution. The text notes 1409 and the time-series data 1404 are stored in a database and are used to train the cross-modal retrieval system described in the exemplary embodiments of the present invention which is a part of the data analytics system 1406.

A human operator 1408 can interact with the cross-modal retrieval system in a number of ways detailed below.

Explaining time-series in natural language, that is, given a time-series segment, the exemplary method retrieves relevant comment texts 1422 that can serve as explanations of the query segment 1420. (FIG. 7)

Searching historical time-series with text description, that is, given a text description 1430 (a natural language sentence or a set of keywords), the exemplary methods retrieve time-series segments that match the description (candidate time-series 1432). (FIG. 8)

Searching historical time-series with example series and text description, that is, given a time-series segment and a text description, the exemplary methods retrieve historical segments that match the description and also resemble the example segment. (FIG. 9)

In summary, the exemplary embodiments of the present invention include a method for unsupervised training and using a cross-modal retrieval system for time-series data and text data. Given a database including paired data of these two modalities, the trained system can retrieve data that are similar to a user-given query from the database. Depending on the modality of the query and retrieved results, the system has the following usages:

Explaining time-series in natural language, that is, given a time-series segment, retrieve relevant comment texts that can serve as explanations of the query segment.

Searching historical time-series with text description, that is, given a text description (a natural language sentence or a set of keywords), retrieve time-series segments that match the description.

Searching historical time-series with reference series and text description, that is, given a time-series segment and a text description, retrieve historical segments that match the description and also resemble the query segment.

At a high-level, the exemplary methods transform the time-series segment and the text comments into points in a common latent space, such that examples of the same class and examples in the same pair are close together. Cross-modal retrieval is performed by finding nearest neighbors of a query in this common space. Concepts discovery is performed by clustering the data points in this space.

Compared to purely supervised or unsupervised methods, the exemplary methods use active semi-supervised learning so that human knowledge can guide the learning while manual labeling effort can be significantly reduced without sacrificing performance.

Most active learning algorithms query the label of individual examples. However, in practice, the set of concepts involved in a dataset in a new application domain are often unknown, making it difficult for an annotator to provide labels for individual examples. To this end, the exemplary methods only use queries regarding whether two examples belong to the same concept or not. After obtaining a sufficient number of pairwise labels, the exemplary methods can then choose to infer the set of concepts and the labels of every example.

The exemplary methods use deep canonical correlation analysis (CCA) as an unsupervised objective. CCA finds transformations of time-series segment and of text data, such that correlated information in the two modalities are emphasized, and uncorrelated information (noises) are minimized. The result is that the transformed data tend to show a clustered structure.

The exemplary methods use deep CCA both in the pre-training stage and in the active learning stage as a regularizer for the supervised objective. The supervised objective encourages embeddings such that examples of the same class are closer to each other than to examples of a different class, regardless of modality. Two active pairwise query selection strategies based on active spectral clustering and GMM are used.

The exemplary embodiments improve the user-friendliness of current time-series analytics software by providing a deep-learning based cross-modal retrieval system for time-series and text notes. This exemplary system only requires users to provide link-or-not labels for a small number of example pairs, which is a significant reduction in human effort compared to annotating the class label for every example in the dataset.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method executed on a processor for embedding learning and clustering for paired multi-modal data using deep canonical correlation analysis (CCA) and active learning with pairwise queries, the method comprising:
collecting time-series data from a plurality of sensors;
training, in an unsupervised manner, a cross-modal retrieval system by using the time-series data and relevant comment texts;
depending on a modality of a query:
retrieving the relevant comment texts from a time-series segment of the time-series data, the relevant comment texts used as human-readable explanations of a query segment;
retrieving relevant time-series segments given a sentence or a set of keywords such that the relevant time-series segments match the sentence or set of keywords; and
retrieving the relevant time-series segments given the time-series segment and the sentence or set of keywords such that a first subset of attributes match the set of keywords and a second subset of attributes resembles the time-series segment.

2. The method of claim 1, wherein the time-series segment and the relevant comment texts are transformed into points in a common latent space.

3. The method of claim 2, wherein the cross-modal retrieval system finds nearest neighbors of the query in the common latent space.

4. The method of claim 1, wherein the cross-modal retrieval system uses multi-modal neural networks to encode the time-series data and the relevant comment texts into vector representations.

5. The method of claim 4, wherein the multi-modal neural networks are trained by a two-stage training algorithm employing examples from a user-provided database of time-series text pairs.

6. The method of claim 5, wherein the first stage of the training algorithm is a deep CCA-based pre-training.

7. The method of claim 6, wherein the second stage of the training algorithm is active clustering.

8. The method of claim 7, wherein the active clustering includes query pair selection based on Gaussian mixture modeling (GMM) and query-based selection using active spectral clustering.

9. A non-transitory computer-readable storage medium comprising a computer-readable program for embedding learning and clustering for paired multi-modal data using deep canonical correlation analysis (CCA) and active learning with pairwise queries, wherein the computer-readable program when executed on a computer causes the computer to perform the steps of:
collecting time-series data from a plurality of sensors;
training, in an unsupervised manner, a cross-modal retrieval system by using the time-series data and relevant comment texts;
depending on a modality of a query:
retrieving the relevant comment texts from a time-series segment of the time-series data, the relevant comment texts used as human-readable explanations of a query segment;
retrieving relevant time-series segments given a sentence or a set of keywords such that the relevant time-series segments match the sentence or set of keywords; and
retrieving the relevant time-series segments given the time-series segment and the sentence or set of keywords such that a first subset of attributes match the set of keywords and a second subset of attributes resembles the time-series segment.

10. The non-transitory computer-readable storage medium of claim 9, wherein the time-series segment and the relevant comment texts are transformed into points in a common latent space.

11. The non-transitory computer-readable storage medium of claim 10, wherein the cross-modal retrieval system finds nearest neighbors of the query in the common latent space.

12. The non-transitory computer-readable storage medium of claim 9, wherein the cross-modal retrieval system uses multi-modal neural networks to encode the time-series data and the relevant comment texts into vector representations.

13. The non-transitory computer-readable storage medium of claim 12, wherein the multi-modal neural networks are trained by a two-stage training algorithm employing examples from a user-provided database of time-series text pairs.

14. The non-transitory computer-readable storage medium of claim 13, wherein the first stage of the training algorithm is a deep CCA-based pre-training.

15. The non-transitory computer-readable storage medium of claim 14, wherein the second stage of the training algorithm is active clustering.

16. The non-transitory computer-readable storage medium of claim 15, wherein the active clustering includes query pair selection based on Gaussian mixture modeling (GMM) and query-based selection using active spectral clustering.

17. A system for embedding learning and clustering for paired multi-modal data using deep canonical correlation analysis (CCA) and active learning with pairwise queries, the system comprising:
a memory; and
one or more processors in communication with the memory configured to:
collect time-series data from a plurality of sensors;
train, in an unsupervised manner, a cross-modal retrieval system by using the time-series data and relevant comment texts;
depending on a modality of a query:
retrieve the relevant comment texts from a time-series segment of the time-series data, the relevant comment texts used as human-readable explanations of a query segment;
retrieve relevant time-series segments given a sentence or a set of keywords such that the relevant time-series segments match the sentence or set of keywords; and
retrieve the relevant time-series segments given the time-series segment and the sentence or set of keywords such that a first subset of attributes match the set of keywords and a second subset of attributes resembles the time-series segment.

18. The system of claim 17, wherein the time-series segment and the relevant comment texts are transformed into points in a common latent space.

19. The system of claim 18, wherein the cross-modal retrieval system finds nearest neighbors of the query in the common latent space.

20. The system of claim 17, wherein the cross-modal retrieval system uses multi-modal neural networks to encode the time-series data and the relevant comment texts into vector representations.
